(19) United States
(12) Patent Application Publication
(10) Pub. No.: US 2025/0192194 A1
(43) Pub. Date: Jun. 12, 2025

(54) SEPARATOR PLATE FOR ELECTROCHEMICAL SYSTEM AND ELECTROCHEMICAL SYSTEM

(71) Applicant: Reinz-Dichtungs-GmbH, Neu-Ulm (DE)

(72) Inventors: Andreas MICHALKE, Ulm (DE); Hans WALDVOGEL, Krumbach (DE); Alexander TRIPPEL, Senden (DE); Maxim VOVCUK, Neu-Ulm (DE); Manuel KAMM, Gannertshofen (DE); Andreas RUOPP, Merklingen (DE); Jonas LEISCHER, Neu-Ulm (DE); Franz SCHWEIGGART, Pfaffenhofen (DE); Steffen ERTHLE, Dornstadt (DE)

(21) Appl. No.: 18/972,574

(22) Filed: Dec. 6, 2024

(30) Foreign Application Priority Data
Dec. 7, 2023 (DE) 20 2023 107 258.5

(51) Int. Cl. H01M 8/0273; H01M 8/0206; H01M 8/0254; H01M 8/0258; H01M 8/0284; H01M 8/1004

(52) U.S. Cl. CPC H01M 8/0273; H01M 8/0206; H01M 8/0254; H01M 8/0258; H01M 8/0284; H01M 8/1004

(57) ABSTRACT

The present disclosure relates to a separator plate for an electrolyzer or for another electrochemical system. The separator plate has a seal along an edge-region of a through-opening, with an outer surface which is topographical at least in sections. The present disclosure also relates to an electrochemical system.

### CROSS REFERENCE TO RELATED APPLICATION

This application claims priority to German Utility Model Application No. 20 2023 107 258.5, entitled “SEPARATOR PLATE FOR ELECTROCHEMICAL SYSTEM AND ELECTROCHEMICAL SYSTEM”, filed Dec. 7, 2023. The entire contents of the above-identified application is hereby incorporated by reference for all purposes.

### TECHNICAL FIELD

The present disclosure relates to a separator plate for an electrolyzer or for another electrochemical system. The present disclosure also relates to an electrochemical system.

### BACKGROUND AND SUMMARY

Electrochemical systems often comprise a stack of separator plates and elements arranged between them, such as membrane electrode assemblies (MEAs). The separator plates comprise through-openings, each of which is connected to a fluid channel of the electrochemical system in a fluid-conducting manner and/or delimits a section of this channel. The through-openings or fluid channels can, for example, supply the electrochemical system with fuels (e.g. hydrogen or methanol), reaction gases (e.g. air or oxygen) or a cooling medium and/or remove reaction products and heated cooling medium from the system. In the case of electrolyzers, water can be supplied and oxygen and hydrogen can be removed.

The fluids supplied in each case should generally only exit or enter the through- openings on one side of the separator plate, in particular in order to flow along the corresponding side of the separator plate. On a corresponding different side of the separator plate, such exit or entry should be prevented. For this purpose, seals are used which, for example, run around the through-opening carrying this fluid, for example in the form of a ring.

As a rule, it is provided that on one side of a separator plate (or a bipolar plate comprising a plurality of separator plates) a first fluid can exit from or enter an associated through- opening and on the corresponding other side another second fluid can exit from or enter a corresponding associated through-opening.

An established type of seal relates to seals that are elastically deformable during assembly and, in particular, during clamping or pressing, or also when the electrochemical system is closed, and which are made of a non-metallic material, such as elastomer seals. Such seals can, for example, be molded directly onto a corresponding side of the separator plate.

It has been shown that the desired sealing effect is not always sufficiently reliable with previous solutions.

The present application is therefore directed to the task of improving the fluidic sealing of separator plates of electrochemical systems and in particular of their through-openings.

This object is at least partially solved by the subject-matter as described herein.

Accordingly, a separator plate for an electrolyzer or other electrochemical system is proposed, the separator plate having a plate component that comprises:
a first side and a second side that faces away from the first side,
a flow field on each of the first and second sides,
several distribution regions with a plurality of channels, whereby each two adjacent channels are separated by a web, and
a plurality of through-openings,
wherein the through-openings on one of the first and second sides are each connected, in a fluid-conducting manner via one of the distribution regions, to the flow field of this side and on the corresponding other side of the first and second sides are each fluidically sealed off from the flow field of this side by a seal of the separator plate, wherein at least one of the seals extends, at least in sections, along an edge region of the through-opening sealed by this seal and has at least one outer surface which, at least in an uninstalled state of the electrochemical system, is topographical at least in sections along this longitudinal extension and/or has a varying height profile.

The seal can be created by an elastomer profile that is molded, inserted, glued, knotted or applied to the separator plate, or the seal becomes formed by the elastomer profile.

According to the present disclosure, it was recognized that a previous lack of sealing effect can result, for example, from the fact that the seals are compressed unevenly along their course. The separator plates typically have large distribution regions with channels, on which the seals of an adjacent separator plate are at least indirectly supported. For example, further components, in particular elastically deformable cell frames or MEAs, can be arranged between the separator plates and the seal can be indirectly supported on an adjacent separator plate via these components.

If a seal of a first separator plate is supported on such a channelled distribution region of an adjacent second separator plate and/or is supported on a channelled distribution region of the separator plate to which the seal is attached and, for example, injection-molded, the seal can be loaded irregularly and thus deformed irregularly. This can impair the sealing effect. Supporting of the above-mentioned type can occur in particular as a result of compressing of the electrochemical system during assembly.

Instead, it is proposed that the seal, which in the prior art typically has a completely flat outer surface, be topographically shaped at least in sections and in particular be provided with a varying height profile. This can, for example, at least partially compensate for the unevenness of the channels and webs of a distribution region of an adjacent separator plate on which a seal is at least indirectly supported.

In particular, the topographical configuration can be present at least in a section of the seal which runs along an uneven section of the separator plate, such as a distribution region with channels and webs and/or a section of the seal that is opposite to or faces an uneven section of an adjacent separator plate. Optionally, a topographical configuration of the type disclosed herein is present in the majority of or in all such sections of the seal.

Separator plates disclosed herein may be single-layer separator plates whose plate components are formed, for example, from a single section of material, in particular a sheet material. However, the separator plates can also each have two individual plates (i.e. two individual plate components) that are firmly connected to each other, for example welded together. The separator plates serve, for example, to electrically contact the electrodes of the individual electrochemical cells (for example fuel cells) and/or to electrically connect adjacent cells (connection of the cells in series). In these cases in particular, they are also referred to as bipolar plates. The separator plates may also serve to dissipate heat that arises in the cells between the separator plates. Such waste heat may arise, for instance, in the conversion of electrical or chemical energy in a fuel cell.

As mentioned, the electrochemical system can be an electrolyzer, but in particular also a fuel cell system, an electrochemical compressor or a redox flow battery.

The channels and webs of the distribution regions, which may be surrounded by and/or partially form a media guiding structure, may be configured to supply an active area of each separator plate and/or individual plate with one or more fluids or media and/or to transport fluids or media away. In particular, the channels can guide the fluids and can be limited by the webs. The active area of a separator plate and/or individual plate can enclose or delimit an electrochemical cell. In fuel cells, the reaction media, i.e. fuel and reaction gases, are usually guided on the sides of the separator plate that face away from each other, while a coolant is guided between the individual plates of the separator plate. In an electrolyzer, reaction media are also guided on the sides of the separator plate that face away from each other, whereas coolant does not need to be guided between any individual plates, if present at all in an electrolyzer.

The through-openings can be configured in accordance with the aspects of the prior art discussed above. The through-openings of the separator plates can be aligned with each other in a stack of separator plates. Alternatively or additionally, they can be arranged to overlap each other, at least in sections. Alternatively or additionally, the through-openings can jointly define a fluid channel and/or delimit it, at least in sections.

The fluid connection of a through-opening to the flow field can include the possibility of a fluid line between these features, without these features necessarily having to structurally merge and/or be directly connected to each other.

The through-openings can be formed into or cut out of the material of the separator plate and, in particular, its plate component. In general, the at least one plate component can be a one-piece component, optionally formed from a homogeneous material such as a metallic material. Beyond this one-piece and homogeneously-formed component made of one material, however, the plate component can have coatings. The separator plate can also be made of plastic.

Like the distribution regions, the flow field can include channels and webs and/or be part of a media guiding structure. Alternatively, the flow field can be free of such structures and, in particular, flat or, in other words, smooth.

The channels and webs of the distribution regions and/or the flow field can be formed into the plate component by hydroforming, embossing and/or deep drawing, for example. In the context of the present disclosure, the term “embossing” or “embossed” may be understood to mean, in particular, hydroforming, roll embossing, stroke embossing and/or deep drawing.

The seal can have a position and/or extension such that fluid that emerges from the through-opening sealed by it can enter at least a partial area of a distribution region assigned to this through-opening. In particular, this can be an area close to and/or directly adjacent to and/or merging into the through-opening. The seal can, for example, fluidically separate this partial area from another partial area of the distribution region and/or from the flow field. In particular, the seal can extend, at least in sections, in the area of one of the distribution regions and/or overlap it and/or cross it. According to one variant, such a distribution region is positioned adjacent to the through-opening sealed by the seal or directly adjoins it.

A distribution region associated with a through-opening can be understood to mean, for example, a distribution region that is set up and, in particular, positioned in such a way as to receive a fluid emerging from the through-opening, in particular directly, or to introduce fluid, in particular directly, into the through-opening. In particular, the associated distribution region can be directly adjacent to the through-opening or positioned at a distance from it, which distance can also be 0 cm, or less than 5 cm, or less than 2 cm. Alternatively or additionally, the assigned distribution region can be the distribution region closest to the through-opening from the plurality of distribution regions.

The seal can consist of or be formed from an elastomer that is injected onto the separator plate in an injection molding process. The elastomer can be FKM (fluoroelastomer), silicone rubber or NBR rubber (nitrile butadiene rubber), PUR (polyurethane), NR (natural rubber), FFKM (perfluoro rubber), SBR (styrene butadiene rubber), BR (butadiene rubber), FVMQ (fluorosilicone), CSM (chlorosulfonated polyethylene), HNBR (hydrogenated nitrile-butadiene rubber), ACM (acrylate rubber), AEM (acrylate-ethylene rubber), EPDM (ethylene-propylene-diene rubber), IIR (butyl rubber) or mixtures of the aforementioned substances. However, the present disclosure is not limited to these materials. Alternatively, the elastomer profile could also be produced using other processes.

The outer surface can be surrounded by at least one sealing lip of the seal. As will be explained below, the seal can have several sealing lips, each of which can have an outer surface and in particular a topographically formed outer surface of the type disclosed here. This is particularly detectable when the separator plate is not installed or not compressed.

The outer surface can define a surface of the seal that is in contact with an adjacent component over most or all of its surface area. This component can be, for example, a MEA or a cell frame as described below. The outer surface may be the only surface of the seal that allows such an installation. If there is a plurality of outer surfaces, for example due to the provision of several sealing lips, these outer surfaces may be the only surfaces of the seal that allow the seal to make corresponding contact.

The seal can largely, and optionally completely, surround the associated through- opening (i.e. the through-opening that is sealed by the seal). Consequently, it can also largely or completely surround an edge region of the through-opening. An extension of the seal along the edge region does not necessarily require a constant distance to this edge region. Such a distance can be measured parallel to the plate plane, for example. According to embodiments, however, a correspondingly constant distance can be provided. Also, the extension of the seal along the edge region does not require a completely parallel extension to this edge region, which, however, can also be provided according to embodiments.

In particular, an extension of the seal along the edge region can be understood to mean that a local extension direction of the seal has a vector component that runs parallel to an extension direction of an adjacent section of the edge region. This vector component can, for example, be greater than a vector component that is orthogonal to the direction of extension of the neighboring section of the edge region.

Where reference is made herein to a separator plate, this may be synonymous with a reference to its plate component(s) and in particular exclusively to this plate component, unless otherwise stated or apparent. As mentioned, a separator plate may optionally include a plurality of plate components of the type disclosed herein.

A topographical outer surface or a general topographical surface can be understood to mean that a surface topography is provided. In particular, this can be synonymous with an uneven and/or not consistently flat shape of the surface.

In particular, a topographical outer surface can be understood to have a varying height profile. The height profile can extend along a height axis. This can run orthogonally to the longitudinal extension of the seal and/or to a plate plane of the separator plate. The varying height profile may comprise varying heights or, in other words, varying positions of the outer surface with respect to this height axis, this variation being present when viewed along the longitudinal extension of the seal. In other words, sealing sections of different and thus varying heights can follow one another along this longitudinal extension. Variations do not always have to achieve the same deflection in relation to the height axis.

In a manner known per se, the flat surface plane of the separator plate can be defined, for example, by an edge of the separator plate and/or its plate component or by those flat regions of a separator plate and/or its plate component which are not deformed as a result of an embossing or deep-drawing process to form the media guiding structure described herein and in particular the distribution regions or also other embossed or deep-drawn structural features. On the one hand, the flat surface planes can run in the neutral fibers of the corresponding sections of a separator plate and/or its plate component; on the other hand, it is also possible to consider the surfaces of the relevant sections of the plates as flat surface planes. With the latter approach, however, it must be ensured that the material thickness of only one of two individual plates considered is taken into account for distances or similar, if available.

A state of a separator plate installed in the electrochemical system may include that it has been mechanically compressed. In the manner described below, the electrochemical system may comprise a plurality of separator plates, in particular stacked on top of one another, the stack being mechanically compressed in a manner known per se. As a result of such compression, the seal can be elastically deformed and the topographical configuration of the outer surface of the seal can be compressed accordingly, any varying height profile of the seal can be adjusted, at least in sections and/or at least partially, to a more uniform height. However, this can be advantageous for achieving a reliable sealing effect and the topographical outer surface disclosed here can specifically promote the achievement of such a uniform height in the installed and, compressed state.

According to one embodiment, the outer surface is shaped similarly to a region of the corresponding one of the first and second sides on which the seal is arranged and along which the outer surface extends. This can apply in particular with regard to a height profile and/or a surface shape and/or surface topography of the outer surface and this area. For example, the outer surface can be corrugated, curved or generally profiled in the same way as the above-mentioned area. The similarity can refer to the general shape of the outer surface and corresponding area, for example in the sense of a corrugated, rectangular or sawtooth shape or generally an alternating sequence of similar shape and/or surface features. It is possible, but not essential, that the exact dimensions of this shape or the respective surface profiles are essentially the same. These dimensions can be, for example, amplitudes and/or period widths of alternating successive shape features, such as protrusions and depressions. It has been shown that pressure ratios can be equalized by means of such similar shaping.

This applies in cases where the side of the separator plate on which the seal is arranged has a complementary shape to a side of an adjacent separator plate, for example one that follows in a stacking direction. In this case, for example, the outer surface of the seal can be locally recessed, but in the stacking direction it can be opposite a complementary raised area of the adjacent separator plate or face such an area. Additionally, or alternatively, the outer surface of the seal can be raised locally, but in the stacking direction it can be opposite a complementary recessed area of the adjacent separator plate or face such an area. This means that the height profiles of the outer surface of the seal and of opposing areas of the adjacent separator plate can be equalized, at least in sections, which can equalize the resulting pressure ratios when assembling and especially when compressing the electrochemical system. In addition, the topographical outer surface of the seal can also be adapted, geometrically out of phase in the longitudinal direction, i.e. in particular adapted geometrically out of phase to a side of an adjacent separator plate following in a stacking direction.

According to a further embodiment, the region to which the outer surface of the seal is similarly shaped comprises a part of one of the distribution regions of the corresponding one of the first and second sides. Accordingly, the seal can cross the distribution region or its web/channel structure, for example in the manner described above, at least in sections. For example, sections of the seal or its outer surface can extend transversely to the longitudinal channel axes of the distribution region or its web-channel structure. Such a distribution region, which is crossed by the seal, for example, preferably does not create a fluid-conducting connection between a through-opening and the flow field. Instead, such a connection is deliberately interrupted by the seal. Such a distribution region can be complementary in shape to a distribution region on the opposite side of the separator plate. This opposite distribution region can specifically establish a fluid-conducting connection. The fluidically sealed distribution region can result from an embossing or other molding process used to produce the opposite fluid-conducting distribution region.

According to a further embodiment, the outer surface of the seal faces away from the corresponding one of the first and second sides on which the seal is arranged. In addition, or alternatively, the outer surface of the seal can be arranged to be brought into contact with a further component (e.g. a MEA or a cell frame) of the electrochemical system, which extends, at least in some areas, parallel to and/or directly opposite the separator plate. Additionally, or alternatively, the outer surface of the seal can extend along a flat surface plane of the plate component.

According to one embodiment, the height profile varies alternately, at least in sections. For example, the height profile can have an alternating sequence of protrusions, optionally with the same dimensions at least in the height direction, and depressions, optionally with the same dimensions at least in the height direction, in particular along the direction of longitudinal extension of the seal. The alternating sections can be evenly spaced. This can correspond to regular and/or periodic alternation. However, they can also be irregularly spaced. This allows, for example, varying web and/or channel widths of the distribution region to be taken into account.

According to one embodiment, the outer surface of the seal is corrugated, at least in sections. This can be understood in particular as that a topography of the outer surface comprises an alternating sequence of wave troughs and wave crests. The transitions between these alternating sections can be rounded. The waveform can represent a particularly suitable adaptation to adjacent areas of the separator plate or opposite areas of an adjacent separator plate (and/or to areas of an adjacent separator plate to which the outer surface faces) for the purpose of pressure equalization.

As mentioned above, a height dimension of the seal can extend orthogonally to a flat surface plane of the plate component.

According to one embodiment, a height difference between a locally lowest point of the outer surface of the seal and the neighboring locally highest point of the outer surface is between 0.01 mm and 1 mm. A lower limit of this range can alternatively be 0.2 mm. An upper limit of this range can alternatively be 0.8 mm. For example, this range can therefore be between 0.2 mm and 0.8 mm.

According to one embodiment, a distance along the longitudinal extension of the seal between a locally lowest point of the outer surface and an adjacent locally highest point of the outer surface is between 0.1 mm and 2.5 mm.

Any local lowest point disclosed herein may be encompassed by a depression and/or wave trough of an alternating protrusion profile or alternating topography of the type disclosed herein. Any local highest point disclosed herein may be encompassed by a protrusion and/or crest of an alternating protrusion profile or topography of the type disclosed herein.

It has been shown that reliable sealing effects can be achieved with the above-mentioned height differences and distances.

According to a further embodiment, the seal has at least two sealing sections protruding from the plate component, for example in the form of sealing lips, which can run parallel to one another. Each of the sealing sections can have an outer surface which, at least in an uninstalled state of the electrochemical system, is topographical and/or has a varying height profile when viewed in the direction of the longitudinal extension, at least in sections.

The present disclosure also relates to an electrochemical system, for example an electrolyzer, comprising a plurality of separator plates according to any of the aspects disclosed herein, wherein the separator plates are arranged in a stack. For example, the separator plates can be stacked on top of each other along a stacking axis. The separator plates can be aligned parallel to each other. Further components of the electrochemical system can be arranged between two separator plates that are directly adjacent along the stacking axis, in particular an MEA, a cell frame, a porous transport layer, PTL, or a gas diffusion layer, GDL. Such a stack, including any other components, can be mechanically compressed before the electrochemical system is put into operation. The deformation of the seals described here can occur at the latest as a result of this compression.

In the electrochemical system, for each pair of adjacent separator plates, the at least one seal having the topographical outer surface may face away from a first separator plate of that pair and toward a second separator plate of that pair. This seal can be supported against, or in other words, on this second separator plate. This enables reliable, at least indirect, support of the outer surface of this seal on the second separator plate to achieve a reliable sealing effect.

According to one embodiment, the topographical outer surface of the at least one seal of the first separator plate is, at least in an uncompressed state of the stacked separator plates, complementary in shape to a region of the second separator plate that is opposite to and/or faces the outer surface. As a result of the compressing, the topography and/or the height profile of the separator plate can better adapt to the topography and/or the height profile of the second separator plate. Alternatively, or additionally, the topography and/or the height profile of the separator plate can be adjusted towards a more uniform topography and/or a more uniform height profile, for example towards a more even shape.

In this context, an opposing component can be understood to be in at least indirect succession, whereby the latter permits the presence of further components between the opposing components. this can be understood to mean that the corresponding features face each other, for example along a certain axis (such as a stacking axis mentioned herein), even if further components may be positioned between them.

According to one embodiment, the at least one seal of the second separator plate that has a topographical outer surface faces away from the first separator plate. This seal can, for example, be opposite to and/or face a third separator plate that is adjacent to the second separator plate. This embodiment can be accompanied by the fact that only one seal with a topographical outer surface is provided between two adjacent separator plates (and more precisely between their plate components) in respect of each through-opening. This enables reliable sealing with a compact stacking height.

According to one embodiment, at least one membrane electrode assembly, MEA, is arranged between the separator plates of each pair of adjacent separator plates. The seal of the first separator plate can be in direct contact with the membrane electrode unit. The seal of the first separator plate can be supported on the second separator plate via the MEA. As a result of the pressure-compensating effect of the topographical outer surface disclosed here, the seal can be supported evenly, and with a correspondingly uniformly reliable sealing effect, on the MEA.

According to a further embodiment, a cell frame is arranged between the separator plates of each pair of adjacent separator plates, in addition to the membrane electrode unit and on both sides of the membrane electrode unit, with the seal of the first separator plate resting against one of the cell frames. More precisely, the seal can rest against the cell frame that is arranged on the side of the MEA that faces the first separator plate.

In general, the cell frames may be planar components, which may be arranged substantially parallel to the separator plates in a stack of the electrochemical system disclosed herein.

The cell frames can be configured in the same way. They can be assembled or combined to form a complete cell frame or interact as such. They can be regarded as partial cell frames of a corresponding whole cell frame. The cell frames can each have a cut-out in which at least one further component of the electrochemical system is accommodated and, is exposed. This component can be the aforementioned MEA, for example. The cell frames can each provide a stiffening function and can be stiffer than the accommodated component for example the MEA. According to one variant, the cell frames comprise a plastic material, in particular polyethylene naphthalate, PEN. In general, the material of the cell frame can be different from that of the accommodated component for example the MEA.

The accommodation of a component by and between the cell frames can include at least one edge region of this component resting against the cell frames and/or being enclosed between them. The cell frames can surround or enclose the accommodated component in a frame-like manner. This relates to an inner circumference or inner edge of the aforementioned accommodating recess, which can be closed and/or have a corresponding frame-like shape.

Exemplary embodiments of the present disclosure will be explained below with reference to the accompanying schematic figures. Similar or equally effective features can be provided with the same reference signs across all figures. Within a particular figure, not all instances of a feature shown are provided with the reference symbol assigned to this feature.

### BRIEF DESCRIPTION OF THE FIGURES

FIG. 1 shows the basic structure of an electrochemical system in the form of an electrolyzer according to an embodiment of the present disclosure.

FIG. 2 schematically shows a first side of a separator plate according to an embodiment of the present disclosure, as it can be used, for example, in the system shown in FIG. 1.

FIG. 3 schematically shows a second side of a separator plate according to an embodiment example of the present disclosure, as can be used, for example, in the system shown in FIG. 1.

FIG. 4 shows a sectional view through a pair of separator plates stacked on top of one another in the uncompressed state, wherein the separator plates can be formed in accordance with an embodiment of the present disclosure and in particular in accordance with the variants of FIGS. 2 and 3.

FIG. 5 shows the pair of separator plates from FIG. 4 in a compressed state.

FIG. 6 is a partial perspective view of the separator plates in the state shown in FIG. 5.

FIG. 7 shows a further example of a sectional view through a pair of separator plates stacked on top of one another in an uncompressed state, wherein the separator plates can be formed in accordance with an embodiment of the present disclosure and in particular in accordance with the variants of FIGS. 2 and 3.

FIG. 8 shows the pair of separator plates from FIG. 6 in a compressed state.

### DETAILED DESCRIPTION

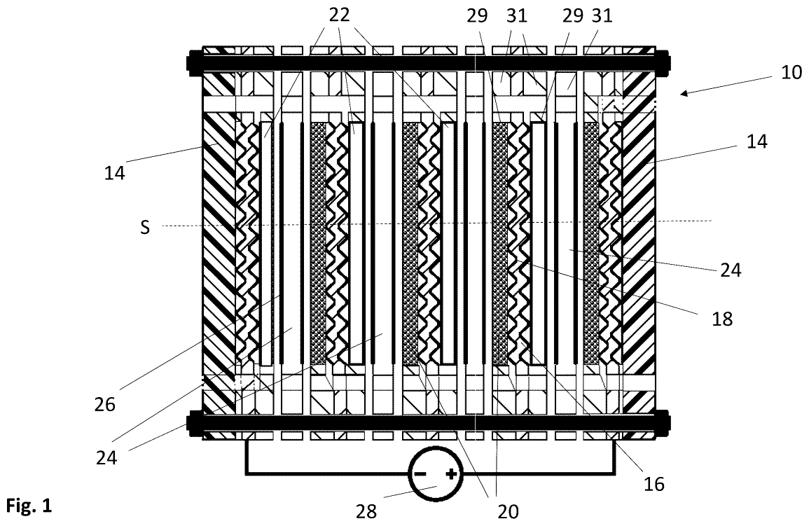

FIG. 1 shows an electrochemical system 10 according to an embodiment of the present disclosure. The electrochemical system 10 is an electrolyzer. The basic structure of this electrolyzer explained here is known in principle. Modifications according to the present disclosure disclosed herein relate in particular to the configuration of the separator plates 18.

The electrolyzer comprises a stack of repeating component sequences as explained below. The stack is arranged and clamped between two boundary plates 14, i.e. it is mechanically pressed together and compressed. All components of the stack are stacked along a stacking axis S or, in other words, lined up next to each other.

Bipolar plates 16 are provided within the stack, which consist of a separator plate 18, that here is installed in a single layer. Each separator plate 18 comprises a plate component 19, which is formed from a single metal sheet and in particular is embossed and/or stamped. The separator plate 18 also comprises seals 33 as explained below.

If reference is made in the following to a separator plate 18, this can be synonymous with a reference to its plate component 19 and in particular exclusively to the plate component 19, unless otherwise stated or apparent.

The separator plate 18 has outward-facing surfaces that face away from each other. These surfaces each form an anode side or a cathode side of the separator plate 18, which is why it accordingly forms a bipolar plate 16. More precisely, a first outward-facing surface of the separator plate 18 is opposite a porous transport layer, PTL, 20 and, in particular, lies against it. The PTL 20 comprises or consists of titanium or a titanium alloy. The corresponding surface or side of the separator plate 18 forms an anode side of the bipolar plate 16.

The corresponding other outwardly-facing surface of the separator plate 18 of each bipolar plate 16 is opposite a gas diffusion layer, GDL, 22 and in particular lies against it. The GDL 22 comprises or consists of carbon and in particular of a carbon fleece. The corresponding surface or side of the separator plate 18 forms a cathode side of the bipolar plate 16.

A membrane electrode assembly 24, MEA, is arranged between a PTL 20 and an adjacent GDL 22. This forms a catalyst carrier which is coated with catalyst materials, see a catalyst layer 26 marked as an example in FIG. 1.

Also shown are cell frame assemblies 31, each comprising two (partial) cell frames that accommodate a component of the electrochemical system 10 between them. These components can be exposed in an accommodating cut-out 29 of the respective cell frame assembly, for example if the component is a PTL or GDL. Other components and in particular a MEA can be clamped between opposing (partial) cell frames and/or squeezed or glued between them. The individual (partial) cell frames are not marked separately in FIG. 1 and are explained below.

During operation of the electrolyzer, water is supplied along the anode side of the bipolar plate 16. In FIG. 1, the direction of flow of the water can, for example, be from vertically upwards to vertically downwards (or vice versa) or from right to left (or vice versa).

The water is split into oxygen, electrons and positively charged hydrogen ions by interacting with an adjacent catalyst layer 26 and by applying a voltage using a voltage source 28. The hydrogen ions diffuse to the cathode side, where they combine with the electrons to form hydrogen. In order to reach the catalyst layer 26, the water must penetrate an adjacent PTL 20.

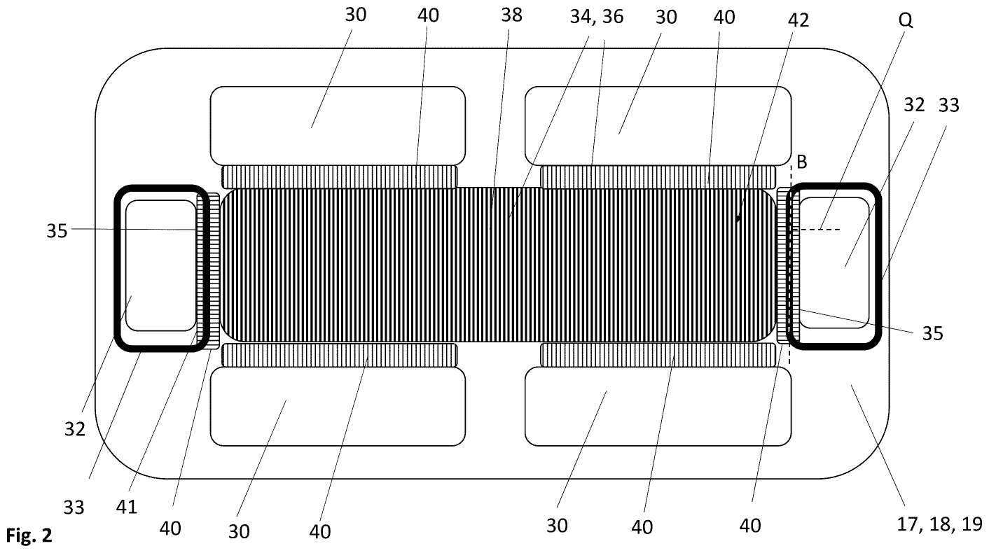

FIG. 2 shows a single separator plate 18 as it can be used in the system 10 of FIG. 1. In FIG. 2, one anode side 17 of the separator plate 18 faces the viewer. The separator plate 18 comprises a plurality of through-openings 30, 32. More precisely, two hydrogen through-openings 32 are provided, each of which is surrounded by a seal 33. The seal 33 prevents a fluid-conducting connection of the hydrogen through-openings 32 to regions of the illustrated anode side 17 of the separator plate 18, which lie outside the seal 33 or the region of the anode side 17 enclosed thereby.

Furthermore, four water through-openings 30 are provided as an example. These are not sealed against a flow field 38 of the illustrated anode side 17 and are therefore connected to it in a fluid-conducting manner. However, the water through-openings 30 and the flow field 38 are sealed off from the surroundings of the electrolyzer. Such a seal is not shown in FIG. 2 for reasons of clarity. For example, it can be located on the separator plate 18 or in a neighboring component.

A media guiding structure 42 consisting of several distribution regions 40 and the flow field 38, each having a channel-web arrangement, is embossed into the anode side 17. The media guiding structure 42 comprises a flow area for the water supplied by means of the water through-openings 30.

The media guiding structure 42 comprises a plurality of channels 34 and webs 36 that extend between and separate the channels, in particular spatially and/or structurally. An extension direction and thus also a respective longitudinal axis of the channels 34 and webs 36, which is not shown separately, runs vertically in FIG. 2 (with the exception of distribution regions 40 of the through-openings 32 discussed below). Consequently, the channels 34 and webs 36 each extend between two opposing water through-openings 30.

The flow area is partly formed by a flow field 38, which is located in an electrochemically active area of the system 10 and in which the conducted water participates in the electrochemical reaction of the electrolyzer. Furthermore, the flow area is partly formed by distribution regions 40, in which no electrochemical reaction or at best a considerably reduced electrochemical reaction takes place. These distribution regions 40 are each assigned to one of the through-openings 30, 32 in order to connect these to the flow field 38 in a fluid-conducting manner, at least in the non-sealed cases disclosed here.

It can be seen that a respective seal 33 in the example shown is not exactly flush with an edge region 35 of the associated through-opening 32, but this can also be provided according to embodiments. In the example shown, however, a respective seal 33 crosses the distribution region 40 of the associated through-opening 32. A partial area 41 of the distribution region 40 is thus still connected in a fluid-conducting manner to the through-opening 32, but not to the adjacent remaining area of the distribution region 40, let alone the flow field 38. In all of the embodiments shown here, a respective seal 33 is made of an elastomer material and is molded onto the separator plate 18, more precisely is molded onto its plate component 19.

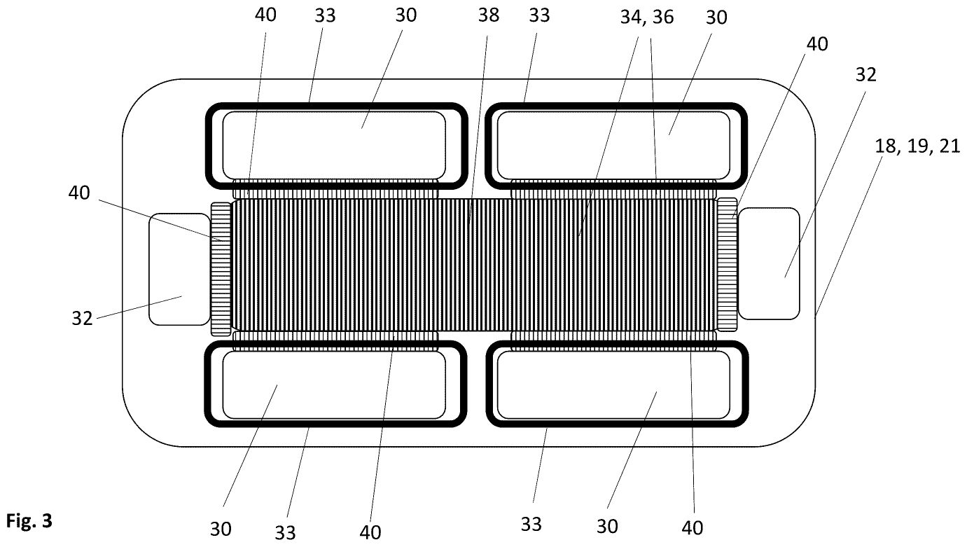

In a manner known per se, the channels 34 and webs 36 on the cathode side 21 of the separator plate 18 that faces away from the observer form a complementary channel-web arrangement. On this cathode side 21, the water through-openings 30 are fluidically sealed by seals 33 and the hydrogen through-openings 32 are fluidically connected to the flow area. This is illustrated in FIG. 3, which shows a view of the cathode side 21 of the separator plate 18 from FIG. 2.

Alternatively, the flow field 38 can also be smooth and without channels and webs. Consequently, the channels and webs considered in the context of the present disclosure are located in particular in the distribution regions 40, in particular those channels and webs which cooperate with a seal 33.

The seals 33 shown in FIG. 3 are configured in the same way as the seals 33 in FIG. 2. Optionally, they in turn cross the distribution regions 40, which connect to the through-openings 30 enclosed by the seals 33.

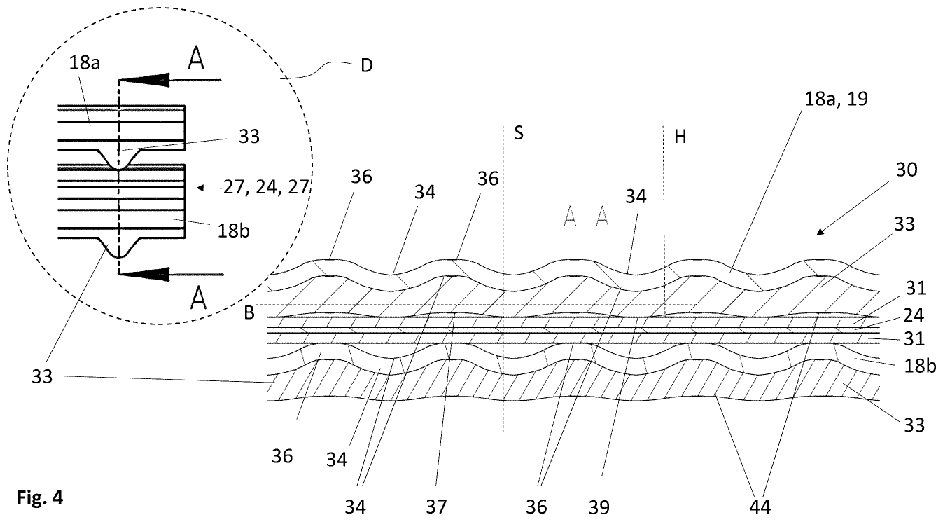

Partial views of separator plates 18 are shown in FIGS. 4-8, whereby the separator plates 18 can be configured in particular according to the examples of FIGS. 2 and 3. The seals 33 discussed below may be any of the seals 33 for sealing any through-openings 30, 32 of a separator plate 18 and in particular any of the seals 33 of FIGS. 2 and 3.

FIG. 4 contains a detailed view D of a pair of separator plates 18 with a sectional axis A-A as well as a sectional view through the separator plates 18 along this sectional axis A-A. FIG. 4 shows a state in which the separator plates 18 are stacked on top of one another and accommodate, as further components of the electrochemical system 10 in which they are installed, two cell frame assemblies 31, for example accommodating a PTL or GDL not shown separately, as well as an MEA 24 arranged between them.

Referring first to the upper separator plate 18a in the sectional view of FIG. 4, it can be seen that the sectional plane extends through a portion of the seal 33 that extends along an area of the separator plate 18 that includes a portion of the media guiding structure 42. In particular, this can be a section of a distribution region 40, as shown in FIG. 2 by an exemplary position of an axis B contained in the sectional plane A-A.

Thus, the region of the separator plate 18, by means of the channels 34 and webs 36 of the distribution region 40 along which the shown portion of the seal 33 extends, is topographic or, in other words, uneven and has an irregular height profile. A height axis H, which is generally orthogonal to a plane of the separator plate 18 not shown separately, is illustrated.

As mentioned, FIG. 2 shows an axis B, which lies in the sectional plane A-A of FIG. 4 and is also shown in FIG. 4. FIG. 2 shows that this axis B extends along an edge region 35 of a through-opening 32, which is sealed by the seal 33 shown in FIG. 4. Thus, the sectional view from FIG. 4 shows a section of the seal 33 that extends along the through-opening 32. A longitudinal direction of extension of the seal 33 or of its outer surface 44 runs in FIG. 4 correspondingly along the axis B and thus horizontally from left to right (or vice versa).

Returning to FIG. 4, it can be seen, that the seal 33 completely fills the surface depressions and protrusions of the separator plate 18 on its inner-facing side of the separator plate 18. This happens because the elastomer seal automatically adapts to the height profile of the separator plate 18 when it is molded onto the separator plate 18 and fills it completely. The inside of the seal 33 thus imitates the channels 34 and webs 36 of the separator plate 18. The seal 33 is topographically shaped on its outer surface 44 that faces away from the separator plate 18. This topographical configuration is defined by the geometry of the injection mold. More precisely, it also has a varying height profile H. In the example shown, this variation is essentially the same as the variation of the separator plate 18 that is adjacent to the outer surface 44 as well as along the longitudinal extension direction, that is, the axis B.

For example, the outer surface 44 of the seal 33 is corrugated in the same way as that side of the here upper separator plate 18 on which the seal 33 is molded and along which the seal 33 extends. Where this side of the separator plate 18 has indentations in the form of channels 34 or wave troughs, the outer surface 44 of the seal 33 also has depressions 37 or wave troughs. Where this side of the separator plate 18 has protrusions in the form of ridges 36 or wave crests, the outer surface 44 also has protrusions 39 or wave crests.

As previously mentioned, the distribution regions 30 of the separator plates 18a, 18b are each shaped in a complementary manner such that the webs 34 formed on a first side or surface of the separator plates 18a, 18b form channels 36 on a second side or surface. Similarly, the channels 36 formed on a first side or surface form webs 34 on a second side or surface. In the context of the previous discussion of FIG. 4, the side of the separator plate 18a to which the seal 33 is directly molded, together with its webs 34 and channels 36, includes the seal 33 which reproduces the web-channel topography of this side on the outer surface 44 of the seal 33 in the form of depressions 37 and protrusions 39.

The protrusions 39 and depressions 37 are defined, for example, from the point of view of an observer looking frontally at the corresponding side of the separator plate 18a, i.e. from an angle different from FIG. 4. Similarly, the protrusions 39 and depressions 37 can form protrusions 39 and depressions 37 with respect to the plane of the separator plate 18a. Similarly, the protrusions 39 and depressions 37 in the cross-sectional view of FIG. 4 and in relation to the stack axis S or height axis H can each be defined as protrusions 39 and depressions 37 in the vertically downward direction and/or orthogonally to the axis B. The apexes of the protrusions 39 comprise the highest local points and the apexes of the depressions 37 comprise the lowest local points of the respective surfaces. The distances between neighboring highest and lowest local points along the height axis H and longitudinally along the axis B may have any values disclosed herein.

The dimensions of the depressions 37 and protrusions 39, for example in terms of amplitude and/or period width of the varying height profile, may be identical when comparing the side of the separator plate 18 that faces the seal 33 with the outer surface 44 of the seal 33. However, they may also deviate from each other, for example by no more than 20%.

FIG. 4 shows that the outer surface 44 of the upper seal 33 is in contact with the upper cell frame assembly 31. The lower cell frame assembly 31, on the other hand, rests against an upper surface of the lower separator plate 18b. This lower separator plate 18b also has a seal 33, which is formed analogously to the upper seal 33 and has a correspondingly topographical outer surface 44. This outer surface 44 is in turn adjacent to a neighboring cell frame assembly 31 in a remaining portion of the stack of the electrochemical system 10, which is not shown. Thus, the outer surface 44 of the seal 33 of the upper separator plate 18a faces in the direction of the neighboring lower separator plate 18b. The seal 33 of this adjacent lower separator plate 18b, and in particular its outer surface 44, on the other hand, faces away from the upper separator plate 18a.

The separator plates 18a and 18b that are shown in FIG. 4 and that are adjacent to one another in the stack of the electrochemical system 10 are arranged in such a way that their sides, which follow one another along the stack axis S and face one another, are shaped complementarily to one another. Thus, an inner side of the upper separator plate 18a has protrusions or ridges 36 in areas where the upper side of the lower separator plate 18b has depressions or channels 34. Similarly, the inside of the upper separator plate 18a has depressions or channels 34 in areas where the upper side of the lower separator plate 18 has protrusions or ridges 36.

The aforementioned upper sides and inner sides of the separator plates 18a and 18b lie opposite each other when viewed along the stacking axis S and are at least indirectly supported against each other when compressed. The protrusions and depressions can in turn be defined from the point of view of an observer who looks frontally at the corresponding sides or areas, different to the viewing angle of FIG. 4.

When pressed together, compressive forces act between the adjacent separator plates 18a and 18b, whereby the separator plates 18 are the most dimensionally stable component of the illustrated plurality of components. In particular, the seals 33 are supported on an adjacent separator plate 18 and by means of the deforming of other components arranged between them, such as the cell frame assemblies 31 and the MEA 24 shown here, that become deformed during compression.

The compressive forces run along the stack axis S. It can be seen, that in the example from FIG. 4, first sections of the outer surface 44 of the upper seal 33, which in particular each comprise protrusions 39, are located at least indirectly opposite to areas of the adjacent separator plate 18 that have recesses or channels 34 when viewed along the stack axis S, and/or face these and are supported on these. Other second sections of the outer surface 44 of the seal 33, which in particular each comprise depressions 37, on the other hand lie opposite and/or face regions of the adjacent separator plate 18 that have protrusions or webs 36. The first sections of the outer surface 44 of the seal 33 experience a correspondingly lower structural support during compression compared to the second sections. Figuratively speaking, a support region provided by the adjacent separator plate 18 for the first sections is further away from these first sections than a corresponding support region for the second sections is away from precisely these second sections.

According to the present disclosure, it has been recognized that this results in a substantially non-uniform deformation of a seal 33 when the outer surface 44 has a non-topographical configuration. This can result in an uneven contact force of the seal 33 on the adjacent cell frame assembly 31. This can be at least partially compensated for with the topographical configuration of the outer surface 44 disclosed here.

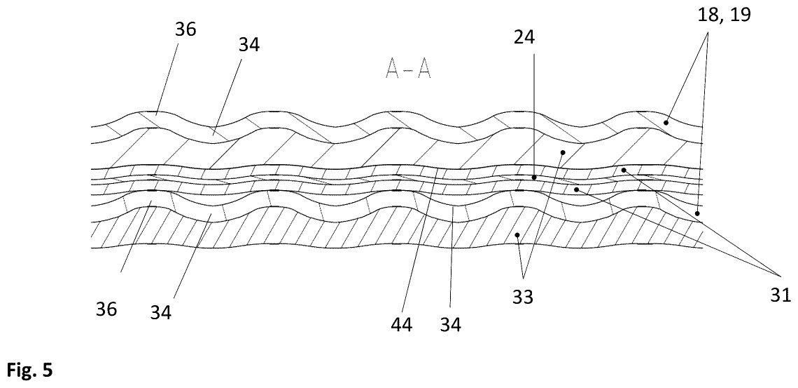

The latter is confirmed by FIG. 5, which shows a sectional view analogous to FIG. 4 in a compressed state of the pair of separator plates 18. It can be seen, that the outer surface 44 of the upper seal 33 is in full contact with the opposing cell frame assemblies 31, even in the areas in which the seal 33 faces recesses (that is, channels) 34 of the adjacent separator plate 18, that is, the seal 33 is supported against these.

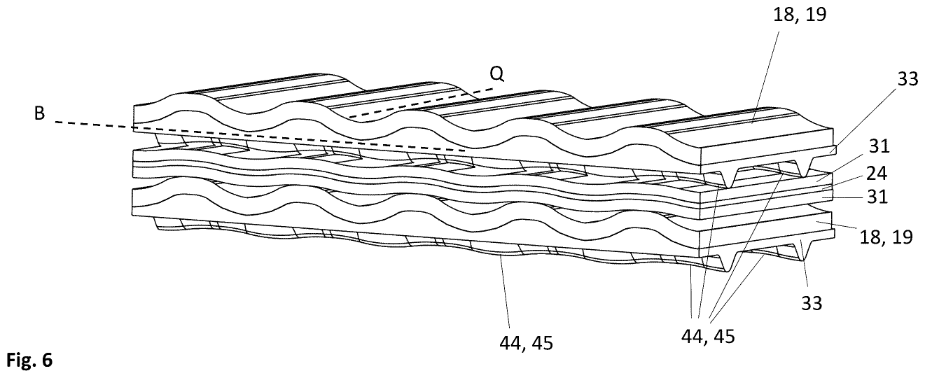

FIG. 6 is a perspective view of the sectional view of FIGS. 4 and 5. A partial section of the pair of separator plates 18 and the components 24, 31 enclosed between them is shown. In particular, the view also shows sections of these components in a transverse direction Q, which runs transverse to the axis B in FIG. 4. As shown in FIG. 2, this transverse direction Q corresponds to a direction transverse to an edge region 35 of the through-opening 32 sealed by the seal 33.

It is shown that, viewed along this transverse direction Q, the seal 33 has two adjacent sealing sections 45, each of which forms a sealing lip. Each of these sealing sections 45 has a topographical outer surface 44 according to the variants discussed above. It has been shown that an improved sealing effect can be achieved with such a configuration compared to a single large-area sealing section 45. Within the scope of the present disclosure, however, it is also possible in principle to provide only a single sealing section 45 together with a single outer surface 44.

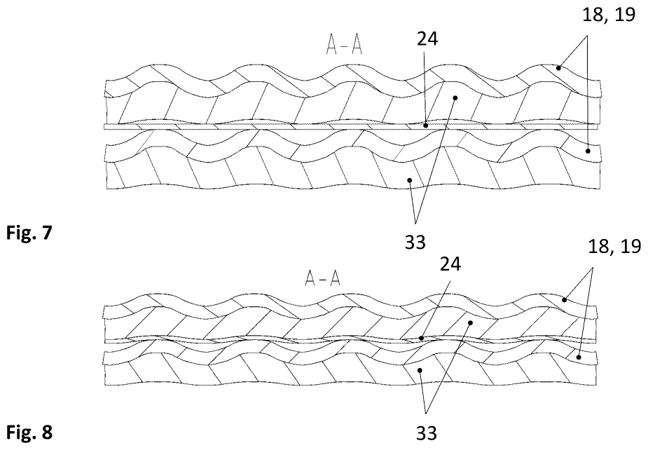

FIGS. 7 and 8 show views analogous to FIGS. 4 and 5 as a further embodiment example. However, they relate to a case in which a MEA 24 is provided between the separator plates 18 without an additional cell frame assembly 31 enclosing them. FIG. 7 again shows an uncompressed state, while FIG. 8 shows a compressed state. For further details and the effects achieved, please refer to the description of FIGS. 4 and 5.

1. A separator plate for an electrolyzer or other electrochemical system, wherein the separator plate has at least one plate component, the plate component comprising:
a first side and a second side facing away from the first side,
a flow field on each of the first side and the second side,
a plurality of distribution regions with a plurality of channels, wherein each two adjacent channels are separated by a web, and
a plurality of through-openings,
wherein the through-openings are each connected to the flow field of one of the first side and the second side in a fluid-conducting manner via one of the distribution regions and are each fluidically sealed off from the flow field on a corresponding other side of the first side and the second side by a seal of the separator plate,
wherein the seal extends, at least in sections, along an edge region of the through-opening that is sealed by the seal and has at least one outer surface which, at least in an uninstalled state of the electrolyzer or the other electrochemical system, is, at least in sections, topographical when viewed along a longitudinal extension.

2. The separator plate according to claim 1, wherein the seal is made of an elastomer material.

3. The separator plate according to claim 1, wherein the topographical configuration of the outer surface has a varying height profile.

4. The separator plate according to claim 1, wherein the outer surface is shaped similarly to a region of a corresponding one of the first side and the second side on which the seal is arranged, and along which the outer surface extends.

5. The separator plate according to claim 4, wherein the region comprises a part of one of the distribution regions.

6. The separator plate according to claim 1, wherein the outer surface faces away from a corresponding one of the first side and the second side on which the seal is arranged.

7. The separator plate according to claim 3, whereby the varying height profile varies alternately, at least in sections.

8. The separator plate according to any claim 1, wherein the outer surface is corrugated, at least in sections.

9. The separator plate according to claim 1, wherein a height dimension of the seal extends orthogonally to a plane surface of the plate component.

10. The separator plate according to claim 1, wherein a height difference between a locally lowest point of the outer surface and an adjacent locally highest point of the outer surface is between 0.01 mm and 1 mm.

11. The separator plate according to claim 1, wherein a distance along the longitudinal extension of the seal between a locally lowest point of the outer surface and a locally highest point of the outer surface adjacent thereto is between 0.1 mm and 2.5 mm.

12. The separator plate according to claim 1, wherein the seal comprises at least two seal sections that project from the plate component, wherein each of the seal sections has an outer surface which, at least in the uninstalled state of the electrolyzer or the other electrochemical system, is topographical in a direction of the longitudinal extension, at least in sections.

13. An electrochemical system comprising a plurality of separator plates according to claim 1, wherein the separator plates are arranged in a stack.

14. The electrochemical system according to claim 13, wherein in each pair of adjacent separator plates, the seal having a topographical outer surface that faces away from a first separator plate of the pair and toward a second separator plate of the pair and is supported on the second separator plate.

15. The electrochemical system according to claim 14, wherein the topographical outer surface of the seal of the first separator plate, at least in an uncompressed state of the stack, is shaped to be complementary to a region of the second separator plate that is opposite to and/or faces the outer surface.

16. The electrochemical system according to claim 14, wherein the seal of the second separator plate that has the topographical outer surface faces away from the first separator plate.

17. The electrochemical system according to claim 14, wherein at least one membrane electrode unit is arranged between the separator plates of each pair of adjacent separator plates, and the seal of the first separator plate abuts against the membrane electrode unit.

18. The electrochemical system according to claim 17, wherein a cell frame is arranged between the separator plates of each pair of adjacent separator plates, the cell frame arranged on both sides of the membrane electrode unit, wherein the seal of the first separator plate rests against the cell frame.

19. The separator plate according to claim 10, wherein the height difference between the locally lowest point of the outer surface and the adjacent locally highest point of the outer surface is between 0.2 mm and 0.8 mm.

20. The separator plate according to claim 11, wherein the distance along the longitudinal extension of the seal between the locally lowest point of the outer surface and the locally highest point of the outer surface adjacent thereto is between 1 mm and 2 mm.
